(19) United States
(12) Patent Application Publication
(10) Pub. No.: US 2002/0061726 A1
(43) Pub. Date: May 23, 2002

(54) Coin scoop for slot machines

(75) Inventors: Robert J. Brzezinski, Sharon, PA (US); Charles A. Knott, Hermitage, PA (US)

Correspondence Address: Daniel A. Thomson, Fourteenth Floor, One Cascade Plaza, Akron, OH, 44308, US

(73) Assignee: Slot Scoops, Inc., Hermitage, PA

(21) Appl. No.: 09/905,523

(22) Filed: Jul. 13, 2001

Related U.S. Application Data
(60) Provisional application No. 60/217,912, filed on Jul. 13, 2000.

(51) Int. Cl. G07D 9/00

(52) U.S. Cl. 453/63

(57) ABSTRACT

A new and improved coin scoop for slot machines is disclosed, including an open end, a closed end, a handle, and nesting points. The scoop allows the easy removal of coins from the slot machine tray or other currency machine. The scoops are made of a lightweight material and are stackable for easy display and storage.

### I. BACKGROUND OF THE INVENTION

A. Field of the Invention

This application claims priority to U.S. Provisional Patent Application Serial No. 60/217,912, entitled COIN SCOOP FOR SLOT MACHINES, filed on Jul. 13, 2000. This invention relates to the art of coin scoops for slot machines, and more particularly to stackable coin scoops for slot machines.

B. Description of the Related Art

Every casino has slot machines, and every year millions of people play them. The machines can utilize a variety of coins, including half-dollars, quarters, dimes, and nickels. Upon winning at a slot machine, the coins are released from the machine into a tray that is approximately 21 ½″ long, 4″ wide, and 2 ⅛″ deep. It is common knowledge that coins can quickly become dirty, and when the slot machine winner removes the coins from the tray, their hands become dirty. Along with the hands becoming dirty, the coins could also contain bacteria or other contaminants. Therefore, it is a desirable object to have a device that allows the winner to collect the coins without having to touch them.

The present invention provides a new and improved coin scoop that allows the winner to remove the coins without touching them, and overcomes certain difficulties inherent in the related inventions while providing better overall results.

### II. SUMARY OF THE INVENTION

In accordance with the present invention, a coin scoop for a slot machine is provided that allows the winner to remove the coins from the tray without touching the coins. The coin scoop comprises a body member having an inside surface and an open end extending upwardly and outwardly from a closed end so as to define a cavity in the body member. The open end and the closed end are interconnected by a sloped top portion, a bottom portion, and a side portion. Accordingly, it an object of the present invention to provide a coin scoop that is stackable.

Another object of the present invention is to provide a coin scoop, wherein the body member further comprises a handle, the handle being connected to the sloped top portion and the side portion.

Yet, another object of the present invention is to provide a coin scoop, wherein the handle is tapered.

Still, another object of the present invention is to provide a coin scoop, wherein the sloped top portion and the bottom portion form a tip.

Further, another object of the present invention is to provide a coin scoop, wherein the tip is adapted to fit into an associated slot machine tray.

Still yet, another object of the present invention is to provide a coin scoop, wherein the body member further comprises at least one nesting point attached to the inside surface of the body member. The nesting point is adapted to support at least a portion of a second coin scoop disposed within the cavity.

Another object of the present invention is to provide a coin scoop, wherein the nesting point extends towards the closed end.

Yet, another object of the present invention is to provide a coin scoop, wherein the body member further comprises a plurality of nesting points attached to the inside surface of the body member.

Further, another object of the present invention is to provide a coin scoop, wherein the body member is made of plastic.

It is yet another object of the present invention is to provide a coin scoop that is a unitary body member for scooping coins, the unitary body member comprises an open end and a closed end oppositely disposed from the open end. The open end and closed end are interconnected by a top portion, a bottom portion, and a side portion, wherein the top portion is sloped towards the closed end and towards the bottom portion. The open end and the closed end define an interior surface of the unitary body member.

Still, another object of the present invention is to provide a coin scoop, wherein the top portion and bottom portion form a first corner, the bottom portion and the side portion form a second corner, and the side portion and the top portion form a third corner.

Further yet, another object of the present invention is to provide a coin scoop, further comprising a nesting point disposed on the interior surface of the first corner.

Another object of the present invention is to provide a coin scoop, further comprising a second nesting point disposed on the interior surface of the second corner.

Yet, another object of the present invention is to provide a coin scoop, further comprising a third nesting point disposed on the interior surface of the third corner, the first, second and third nesting points extending toward the closed end.

Still yet, another object of the present invention is to provide a coin scoop, wherein the closed end is adapted to be received within the cavity of a second coin scoop.

In accordance with another aspect of the present invention, a stackable body member for collecting currency includes an open end, a closed end oppositely disposed from the open end, the open end and closed end being interconnected by a top portion, a bottom portion, and a side portion, wherein the top portion is sloped towards the closed end and towards the bottom portion, a tip formed by the top portion and the bottom portion, the tip being adapted to fit in associated currency machine tray, a handle integrally formed with the body member, the handle being tapered, the handle being connected to the sloped top portion and the side portion, wherein the handle is positioned such that associated currency disposed in the tray may be collected in the body member without the currency directly contacting an associated hand of a user, a first corner formed between the bottom portion and the top portion, a second corner formed between the bottom portion and the side portion, a third corner formed between the side portion and the top portion, the first, second, and third corners being curved, a first nesting point disposed on the inside surface of the first corner, a second nesting point disposed on the inside surface of the second corner, and a third nesting point disposed on the inside surface of the third corner the first, second and third nesting points extending toward the closed end.

In accordance with another aspect of the present invention, the scoop is sloped to allow different size coins to be stacked.

In accordance with another aspect of the present invention, the scoop has a curved handle for easy gripping.

One advantage of the present invention is that the scoop allows the winner to remove the coins without touching them.

Another advantage of the present invention is that the scoops are stackable and have nesting points so that the scoops can be easily removed.

Yet another advantage of the present invention is that the scoop is designed for easy gripping and easy removal of the coins from the tray.

Still another advantage of the present invention is that the scoop is relatively inexpensive and lightweight.

Another advantage of the present invention is that the scoop can have the trademark of the casino emblazoned on the outside.

Still other benefits and advantages of the invention will become apparent to those skilled in the art upon a reading and understanding of the following detailed specification.

### III. BRIEF DESCRIPTION OF DRAWINGS

The invention may take physical form in certain parts and arrangement of parts, at least one embodiment of which will be described in detail in this specification and illustrated in the accompanying drawings which form a part hereof and herein:

FIG. 1 is a side view of the inventive coin scoop, showing the open end of the scoop;

FIG. 2 is a perspective view of the inventive scoop, showing the interior of the scoop and a nesting point;

FIG. 3 is a front perspective view of the inventive scoop showing the sloped top;

FIG. 4 is another front perspective view of the inventive scoop showing the tapered handle; and,

FIG. 5 is a perspective view of a slot machine having a tray positioned thereunder.

### IV. DESCRIPTION OF THE EMBODIMENTS

Referring now to the drawings wherein the showings are for purposes of illustrating at least one embodiment of the invention only and not for purposes of limiting the same. With reference now to the figures, a coin scoop 10 is made of a plastic material that is lightweight and relatively inexpensive, such as polypropylene, but not limited thereto. The scoop 10 is molded into a unitary body member, comprising an open end 12 for insertion and removal of currency, a closed end 14, three nesting points 16, which allow the scoop 10 to be easily stackable, and a molded handle 18 for easy gripping. The scoop 10 is essentially hollow to define a cavity 13 therein, and includes the handle 18, which extends upwardly and outwardly from a bottom portion 15 of the scoop 10, as shown in the figures. The scoop 10 has an inside surface 11, a sloped top portion 28, a bottom portion 15, and a side portion 30 interconnecting the open end 12 and the closed end 14.

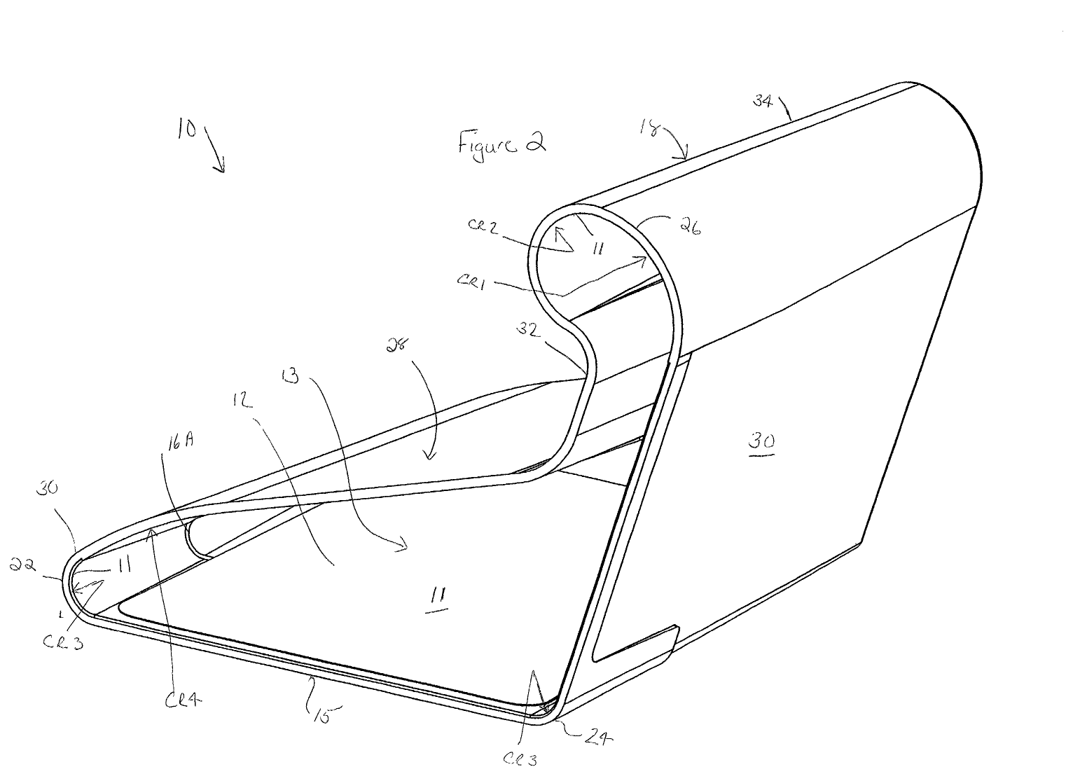

FIG. 2 shows one of the nesting points 16A, which allows the scoops 10 to be readily stacked. When the closed end 14 of the scoop 10 is inserted into the open end 12 of a second scoop 10, the nesting points 16 prevent the first scoop 10 from completely sliding into the second scoop, thereby preventing the first scoop 10 from becoming lodged in the second scoop 10. Each nesting point 16 supports at least a portion of the second scoop 10. In this embodiment, there are three nesting points 16A, 16B, 16C, one at each corner 22, 24, 26 of the scoop 10, and the nesting points 16 are designed as downwardly extending, narrows extensions. However, it is to be understood that any number of nesting points 16 could be used, as well as any design, as long as it is chosen using sound engineering judgment. It is also to be understood that the invention would also work without the nesting points 16.

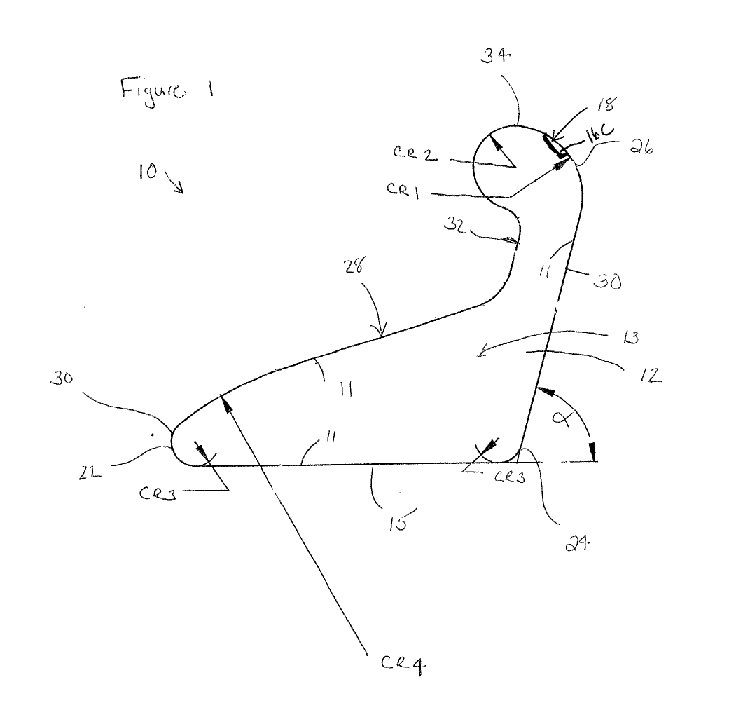

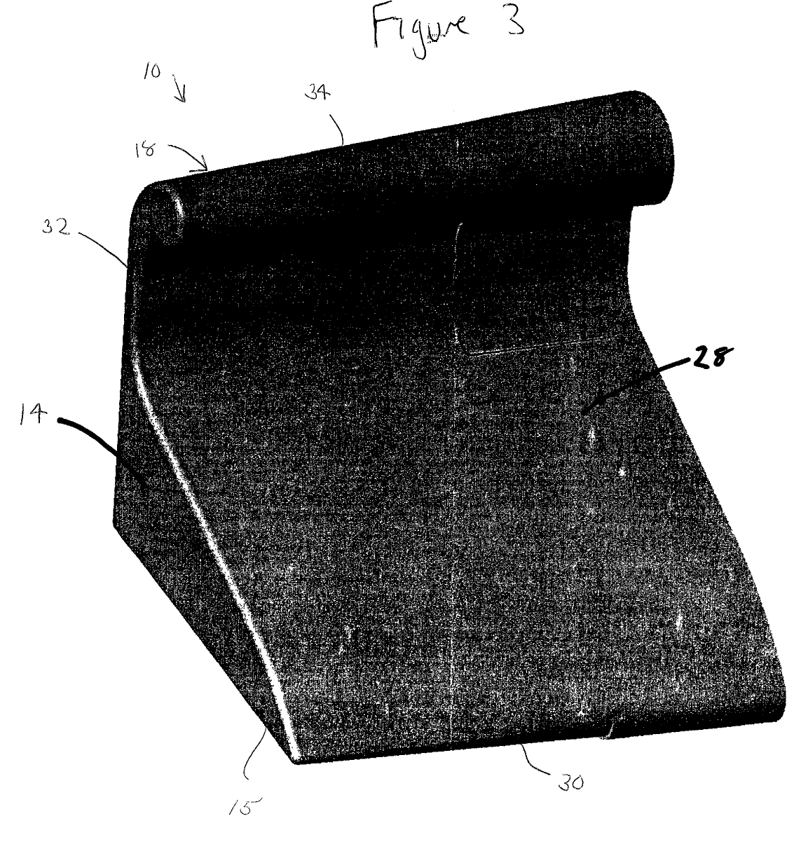

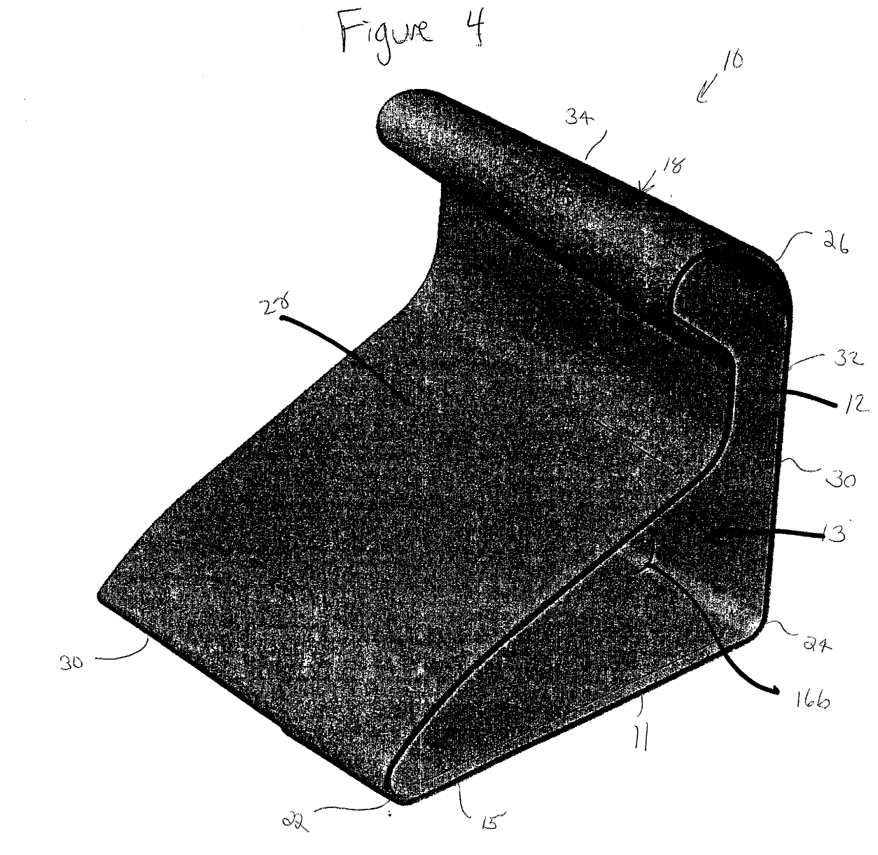

In one embodiment, as shown in FIGS. 1-4, the scoop 10 is sloped downwardly from the open end 12 to the closed end 14, forming a sloped top 28. As described in more detail below, the sloped top 28 also slopes from the handle 18 or side portion 30 towards the bottom 15. This sloped top 28 allows for the easy removal of the coins from the tray 52. When the winner slides the scoop 10 across the tray 52 and reaches the other side, the scoop 10 needs to be removed from the tray 52. With the sloped scoop 10, the coins will tend to be located toward the closed end 14 of the scoop, so that when the scoop 10 is removed from the tray 52, the coins will not fall out of the scoop 10.

It can also be seen in FIGS. 1 and 2 that the handle 18 is angled with respect to the bottom portion 15 of the scoop 10. The handle 18 is angled because the front wall of the slot machine tray 52, particularly in the quarter machines, is angled downwardly from the top. As shown in FIGS. 1 and 2, the handle 18 comprises a neck 32 and a gripping portion 34 attached thereto. The gripping portion 34 is curved, which is formed by a plurality of curvature radii CR1, CR2. It is to be understood that the scoop 10 could be made without a handle 18 without departing from the spirit and scope of the present invention. Further, the handle 18 can be made in any manner with any geometrical configuration, as long as sound engineering judgment is utilized. The handle 18 shown in the figures is only one embodiment of this invention and is not intended to limit the invention in any manner.

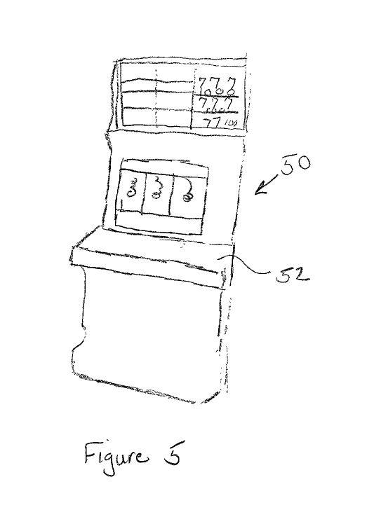

As can be seen from FIGS. 1-4, the scoop 10 is also angled downwardly from the handle 18 to the tip 30 of the scoop 10. As the sloped top 28 extends towards the bottom 15, it slightly curves, forming a curvature radius CR4. This tapered angle allows the tip 30 of the scoop 10 to fit into the back part of the slot machine tray 52. The back part of the slot machine tray 52 is located slightly underneath a portion of the slot machine 50, as shown in FIG. 5. The particular angle of the scoop 10 shown in the figures is only one embodiment of the present invention and is not intended to limit the invention in any manner. The scoop 10 can be designed in any manner desired as long as the scoop is capable of removing the coins from the tray 52 and the design is chosen using sound engineering judgment. It is contemplated to be within the scope of the present invention that the coin scoop 10 may be utilized in association with any currency or coinage machine.

Although in this embodiment the scoop 10 is made out of plastic, it is to be understood that the scoop 10 can be made out of any material chosen using sound engineering judgment.

The following dimensions are given for the purpose of example only and are not intended to serve as limitations in any manner whatsoever. Any dimensions may be utilized that are chosen in accordance with sound engineering judgment. The distance from the bottom 15 to the handle 18 may range from approximately 3 inches to approximately 5 inches, and more preferably is substantially 3 ½ inches. The length of the bottom portion 15 may range from approximately 2 ½ inches to approximately 3 ½ inches, and more preferably is about 3 inches. The length of the side portion may range from approximately 2 inches to approximately 3 inches, and more preferably is about 2 ½ inches. The side portion forms an angle αrelative to the bottom 15. As shown in FIG. 1, α may range from substantially 65 degrees to substantially 85 degrees, and more preferably is about 75 degrees. The first and second corners 22, 24, have curvature radii CR3 ranging between ⅛ inch and ⅜ inch, but more preferably are ¼ inch.

Further, as the sloped top 28 extends towards the bottom 15, it slightly curves. The curvature radius CR 4 ranges from approximately 3 inches to approximately 3 ½ inches, and more preferably is approximately 3 ⅛ inches. As shown in FIG. 1, the curvature radius for the sloped top 28 begins when the sloped top 28 is approximately 1 inch from the bottom portion 15.

Continuing to view FIG. 1, the handle 18 protrudes from the coin scoop 10 at a distance of approximately 1.625 inches from the bottom 15. The handle neck 32 also extends upwardly and outwardly from the bottom 15. The neck 32 may range from approximately 1/2 inch to approximately ¾ inch at the open end 12, and more preferably is approximately 1/2 inch in thickness. As shown in FIG. 1, the first curvature radius CR1 is approximately ¾ inch and the second curvature radius CR2 is approximately 0.4 inches.

The invention has been described with reference to one embodiment. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A stackable coin scoop, comprising:
a body member having an inside surface and an open end extending upwardly and outwardly from a closed end so as to define a cavity in the body member, the open end and the closed end being interconnected by a sloped top portion, a bottom portion, and a side portion.

2. The stackable coin scoop of claim 1, wherein the body member further comprises a handle, the handle being connected to the sloped top portion and the side portion.

3. The stackable coin scoop of claim 2, wherein the handle is tapered.

4. The stackable coin scoop of claim 1, wherein the sloped top portion and the bottom portion form a tip.

5. The stackable coin scoop of claim 4, wherein the tip is adapted to fit into an associated slot machine tray.

6. The stackable coin scoop of claim 1, wherein the body member further comprises at least one nesting point attached to the inside surface of the body member, the nesting point adapted to support at least a portion of a second coin scoop disposed within the cavity.

7. The stackable coin scoop of claim 6, wherein the nesting point extends towards the closed end.

8. The stackable coin scoop of claim 6, wherein the body member further comprises a plurality of nesting points attached to the inside surface of the body member.

9. The stackable coin scoop of claim 1, wherein the body member is made of plastic.

10. The stackable coin scoop of claim 1, wherein the closed end is adapted to be received within the cavity of a second coin scoop.

11. A unitary body member for scooping coins, the unitary body member comprising:
an open end; and,
a closed end oppositely disposed from the open end, the open end and the closed end being interconnected by a top portion, a bottom portion, and a side portion, wherein the top portion is sloped towards the closed end and towards the bottom portion, wherein the open end and the closed end define an interior surface of the unitary body member.

12. The unitary body member of claim 11, further comprising:
a handle integrally formed with the body member.

13. The unitary body member of claim 12, wherein the handle is tapered.

14. The unitary body member of claim 12, wherein the handle is connected to the sloped top portion and the side portion.

15. The unitary body member of claim 1 1, wherein the top portion and the bottom portion form a tip, the tip being adapted to fit into an associated coinage machine tray.

16. The unitary body member of claim 15, wherein the handle is positioned such that associated coins disposed in the tray may be collected in the unitary body member without the coins directly contacting an associated hand of a user.

17. The unitary body member of claim 11, wherein the top portion and bottom portion form a first corner, the bottom portion and the side portion form a second corner, and the side portion and the top portion form a third corner.

18. The unitary body member of claim 17, further comprising a nesting point disposed on the interior surface of the first corner.

19. The unitary body member of claim 18, further comprising:
a second nesting point disposed on the interior surface of the second corner; and,
a third nesting point disposed on the interior surface of the third corner, the first, second and third nesting points extending toward the closed end.

20. A stackable body member for collecting currency, the body member comprising:
an open end;
a closed end oppositely disposed from the open end, the open end and closed end being interconnected by a top portion, a bottom portion, and a side portion, wherein the top portion is sloped towards the closed end and towards the bottom portion;
a tip formed by the top portion and the bottom portion, the tip being adapted to fit in associated currency machine tray;
a handle integrally formed with the body member, the handle being tapered, the handle being connected to the sloped top portion and the side portion, wherein the handle is positioned such that associated currency disposed in the tray may be collected in the body member without the currency directly contacting an associated hand of a user;
a first corner formed between the bottom portion and the top portion;
a second corner formed between the bottom portion and the side portion;
a third corner formed between the side portion and the top portion, the first, second, and third corners being curved;
a first nesting point disposed on the inside surface of the first corner;
a second nesting point disposed on the inside surface of the second corner; and,
a third nesting point disposed on the inside surface of the third corner the first, second and third nesting points extending toward the closed end.
